(19) United States
(12) Patent Application Publication
(10) Pub. No.: US 2022/0318937 A1
(43) Pub. Date: Oct. 6, 2022

(54) SYSTEM AND METHOD FOR RECEIVING AND STORING DATA AND GENERATING COMPILED DATABASES BASED ON THE DATA

(71) Applicant: THE TURNKEY FOUNDATION, INC., Santa Ana, CA (US)

(72) Inventors: Ryan James O'Kane, Laguna Niguel, CA (US); David Edwin Arvidson, Santa Ana, CA (US)

(21) Appl. No.: 17/224,043

(22) Filed: Apr. 6, 2021

(51) Int. Cl. G06Q 50/16; G06Q 40/02

(52) U.S. Cl. CPC G06Q 50/167; G06Q 40/025

(57) ABSTRACT

A method for generating real estate offers comprising the steps: creating a request for a loan pre-approval document on a real estate transaction application by a realtor; transmitting, by said real estate transaction application, said request for a loan pre-approval document to a loan officer via said real estate transaction application; collecting, by said loan officer, one or more financial documents for preparing said loan pre-approval document; generating, by said loan officer, said loan pre-approval document, wherein said loan pre-approval document is stored on said real estate transaction application; sending, by said real estate transaction application, to said realtor, an electronic notification that said loan pre-approval document has been prepared by said loan officer; selecting, by said realtor, a residential purchase agreement document; generating an offer package by said real estate transaction application.

### FIELD OF USE

Embodiments of the present disclosure generally relate to the field of real estate offer services. More specifically, embodiments of the disclosure relate to systems and methods for guided data compilation and extraction of relevant data based on requirements set forth in external documentation.

### BACKGROUND

Transaction involving substantial amounts of documents and capital can be a relatively difficult and lengthy process. One major source of complication during large transactions involving documents and capital, such as a real estate transaction, is based on the fact that many purchases require financing, and lenders are hesitant to provide loans without having processed enormous amounts of information.

The process for an individual to obtain financing may be lengthy and require processing of numerous documents, and the difficulty may be compounded by the fact that the documents must remain up-to-date, even as time passes between pre approval, making offers, and actually making a purchase.

Additionally, much of this process involves input or supervision by a human, which has the possibility of introducing additional errors and delay into an already lengthy process. In some cases, by the time the human processes the paperwork provided, the paperwork is already out of date and must be updated accordingly.

Accordingly, what is needed is a system and method for generating, collecting, storing, and processing data related to complex transactions, including real estate transactions that may result in an overall simplified process and enhance the state of the art of the technology used.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a system and method that provide for automatic generation of documents based on input documents and data. The system and method of the present disclosure is typically beneficial in transactions involving processing of numerous documents that must remain updated over a period of time.

One embodiment may be a method for generating real estate offers comprising the steps: providing a real estate transaction application to a realtor and loan officer to be installed on their respective computers; creating a request for a loan pre-approval document on the real estate transaction application by the realtor; transmitting, by the real estate transaction application, the request for a loan pre-approval document to the loan officer; collecting, by the loan officer, one or more financial documents for preparing the loan pre-approval document; generating, by the loan officer, the loan pre-approval document, wherein the loan pre-approval document may be stored on the real estate transaction application; sending, by the real estate transaction application, to the realtor, an electronic notification that the loan pre-approval document has been prepared by the loan officer; selecting, by the realtor, a residential purchase agreement document; extracting data, by the real estate transaction application, from the residential purchase agreement document and the loan pre-approval document; and generating an offer package by the real estate transaction application. The method may further comprise the step of exporting the offer package by the real estate transaction application to a readable format. The method may further comprise the step of transmitting, by the real estate transaction application, the offer package in the readable format to a seller agent. The one or more financial documents may be uploaded to the real estate transaction application. The one or more financial documents may be modified by the loan officer on the real estate transaction application by redacting information. The offer package may comprise the loan pre-approval document, the financial documents, an offer letter, and an offer summary. The offer summary may comprise an offer price, an estimated time to close escrow, a lender, a down payment, a financing amount, and an offer deadline. The financial documents may comprise proof of income documents, proof of funds documents, and credit score documents.

Another embodiment may be a method for generating real estate offers comprising the steps: providing a real estate transaction platform to a first person and second person via the internet to be accessed on their respective networked computers; building, on the real estate transaction platform, a purchaser profile by the first person, wherein the purchaser profile may comprise information regarding a home purchaser; creating a request for a loan pre-approval document on the real estate transaction platform by the first person; transmitting, by the real estate transaction platform, the request for a loan pre-approval document to the second person; collecting, by the second person, one or more financial documents for preparing the loan pre-approval document; generating, by the second person, the loan pre-approval document, wherein the loan pre-approval document may be stored on the real estate transaction platform; sending, by the real estate transaction platform, to the first person, an electronic notification that the loan pre-approval document has been prepared by the second person; selecting, by the first person, a residential purchase agreement document; extracting data, by the real estate transaction platform, from the residential purchase agreement document and the loan pre-approval document; and generating an offer package by the real estate transaction platform. The method may further comprise the step of exporting the offer package by the real estate transaction platform to a readable format. The method may further comprise the step of transmitting, by the real estate transaction platform, the offer package in the readable format to a seller agent. The one or more financial documents may be uploaded to the real estate transaction platform. The offer package may comprise the loan pre-approval document, the financial documents, an offer letter, and an offer summary. The offer summary may comprise an offer price, an estimated time to close escrow, a lender, a down payment, a financing amount, and an offer deadline. The financial documents may comprise proof of income documents, proof of funds documents, and credit score documents. The real estate transaction platform may convert the loan pre-approval document and financial documents into a single format. The real estate transaction platform may combine the loan pre-approval document and the financial documents into a single reference document. The one or more financial documents may be modified by the loan officer on the real estate transaction application by redacting information.

In one embodiment, the real estate offer generation program may allow communication in transfer of documents between a realtor, loan officer, and purchaser's agent.

In one embodiment, information may be populated into fillable forms on the real estate offer generation program by extracting relevant information from documents uploaded to the real estate offer generation program. in some embodiments, the realtor or loan officer may be able to review the automatically extracted and filled information to confirm accuracy and make changes on an as needed basis.

In one embodiment, when using the real estate offer generation program, the realtor may be able to request a loan pre-approval from a loan officer, and after the loan officer prepares the loan pre-approval, the realtor may be automatically notified by an electronic communication.

In some embodiments, the realtor and loan officer may exchange or share documents via the real estate offer generation program.

In some embodiments, the real estate offer generation program may combine various documents to prepare an offer package for the realtor to present to a potential purchaser.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow diagram of one embodiment of a real estate offer generation method.

FIG. 2 is one embodiment of a realtor electronic dashboard of a real estate offer generation program.

FIG. 3 is one embodiment of an offer page of a real estate offer generation program.

FIG. 4 is one embodiment of a loan electronic dashboard of a real estate offer generation program.

FIG. 5 is one embodiment of a loan pre-approval page of a real estate offer generation program.

FIG. 6 is a screenshot of one embodiment of a financial document accessed by a real estate offer generation program.

### DETAILED DESCRIPTION OF THE EMBODIMENTS

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still others will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices. The storage can be local or remote, for example, in a Cloud Computing environment.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In the following description, certain terminology is used to describe certain features of the embodiments disclosed herein. For instance, the terms “computer”, “computer system”, “computing device”, mobile computing device”, “electronic data processing unit”, or “server” refer to any device that processes information with an integrated circuit chip, including without limitation, personal computers, mainframe computers, workstations, servers, desktop computers, portable computers, laptop computers, embedded computers, wireless devices, including cellular phones, personal digital assistants, tablets, tablet computers, smart phones, portable game players, wearables, smart devices and hand-held computers.

As used herein, the term “Internet” refers to any collection of networks that utilizes standard protocols, whether Ethernet, Teletype, Type B Messaging, Edifact, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the term “website” refers to any document written in a mark-up language including, but not limited to, hypertext mark-up language (HTML) or virtual reality modeling language (VRML), dynamic HTML, extended mark-up language (XML), wireless markup language (WML), javascript object notation (JSON) or any other computer languages related thereto, as well as to any collection of such documents reachable through one specific Internet Protocol Address or at one specific World Wide Web site, or any document obtainable through any particular Uniform Resource Locator (URL). Furthermore, the terms “webpage,” “page,” “website,” or “site” refers to any of the various documents and resources on the World Wide Web, in HTML/XHTML format with hypertext links to enable navigation from one page or section to another, or similar such resources used on the Internet.

### Lexicon—Meaning of Certain Acronyms, Initialisms. And Terms

Unless otherwise stated herein the following acronyms and initials stand for the following meaning:
Realtor, as used herein, may refer to realtors, real estate agents, seller agents, buyer agents, or an individual involved in the sale of real estate.
Loan Officer, as used herein, may refer to loan officers or other individuals involved in obtaining financing for a mortgage.
Purchaser, as used herein, may refer to potential purchasers of real estate, clients of realtors, or other individuals seeking to obtain a loan to purchase property.
Program, as used herein, may refer to software applications, online portals, SaaS (Software as a Service), and other computer processed methods.

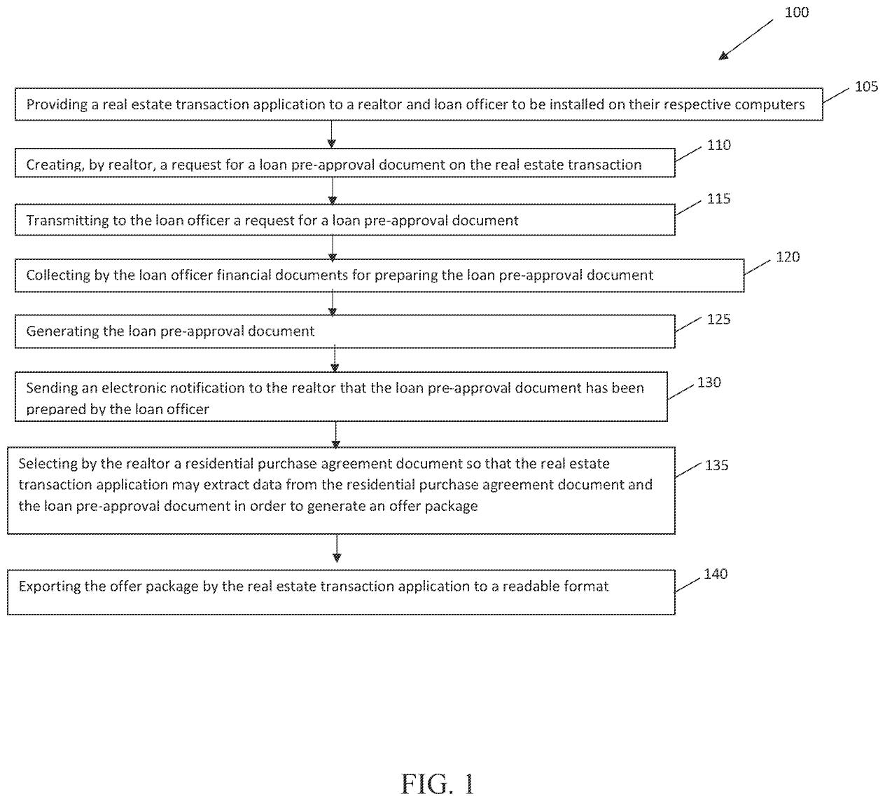

FIG. 1 is a flow diagram of one embodiment of a real estate offer generation method. As shown in FIG. 1, the real estate offer generation process 100 may begin by providing a real estate transaction application to a realtor and loan officer to be installed on their respective computers 105. In some embodiments, the real estate transaction application may be replaced with an on line version, wherein the application need not be downloaded onto the realtor or loan officer's computer. In an alternate embodiment, the real estate transaction application may be installed on two local computers or accessed via the Internet without requiring any installation.

Next, the realtor may create a request for a loan pre-approval document on the real estate transaction 110. Then, the request for a loan pre-approval document may be transmitted to the loan officer 115.

The loan officer may collect one or more financial documents for preparing the loan pre-approval document 120 and then generate the loan pre-approval document 125. The one or more financial documents may be stored and accessed on the real estate transaction application. When accessed within the real estate transaction application, the one or more financial documents may be modified, such as by redacting information that may be too sensitive to transmit on line to other parties. The loan pre approval document may be generated by combining the one or more financial documents into a single file, with whatever modifications are made to the one or more financial documents by the loan officer. In a preferred embodiment, the one or more financial documents may be of varying format, while the loan pre approval document maybe a single file in a single format, such as a PDF. One advantage to this embodiment is that the one or more financial documents may be provided in substantially any format, and the loan pre approval document generated therefrom may be a standardized format, which may have the effect of reducing the amount of time that it takes to generate a loan pre approval document that may be reviewed by a realtor.

The loan pre-approval document may be stored on the real estate transaction application, along with the financial documents used to prepare the loan pre-approval document. After the loan pre-approval document has been generated, and preferably stored on the real estate transaction application, an electronic notification may be sent to the realtor that the loan pre-approval document has been prepared by the loan officer 130. Once the realtor has the loan pre-approval document, preferably along with the financial documents used to generate the loan pre-approval document, the realtor may select a residential purchase agreement document so that the real estate transaction application may extract data from the residential purchase agreement document and the loan pre-approval document in order to generate an offer package 135.

In some embodiments, the offer package may be exported by the real estate transaction application to a readable format 140 and transmitted to a seller agent or other entity.

The offer package may comprise the loan pre-approval document, the financial documents, an offer letter, and an offer summary. The offer summary may include an offer price, estimated time to close escrow, lender, down payment, financing amount, and offer deadline. The financial documents may comprise proof of income documents, proof of funds documents, credit score documents, and any other documents related to the past, present, or future financial condition of the purchaser.

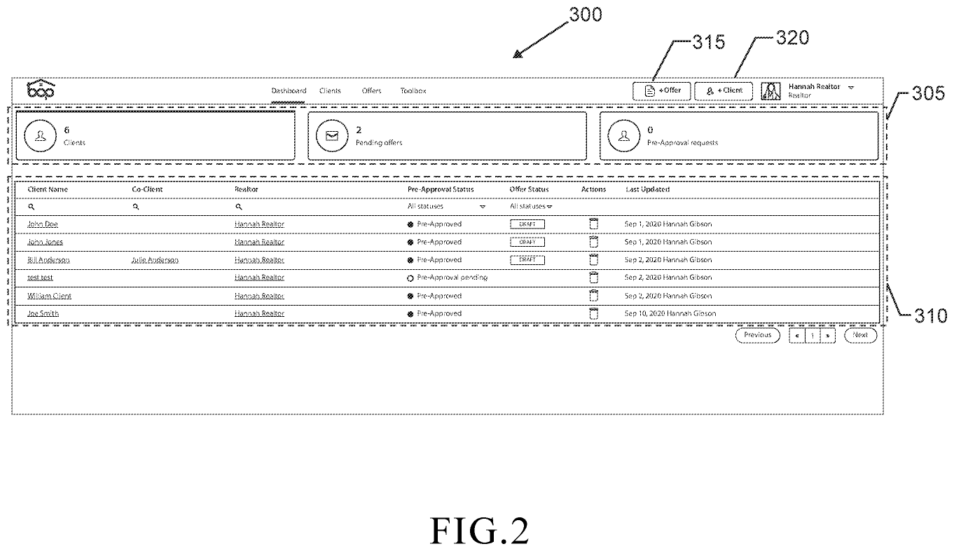

FIG. 2 is one embodiment of a realtor electronic dashboard of a real estate offer generation program. As shown in FIG. 2, the real estate offer generation program may include a realtor electronic dashboard 300 available to a realtor, so that the realtor may manage and organize various clients and monitor progress with respect to obtaining loan pre-approval and sending out offers. In one embodiment, the realtor electronic dashboard 300 may be accessed and used primarily by a realtor.

The realtor electronic dashboard 300 may comprise an overview panel 305, a status panel 310, an offer button 315, and a client button 320. The overview panel 305 may provide access to commonly used screens, and include a number that indicates a summary of pending information. For example, the overview panel 305 may show the number of clients, number of pending offers, and pre-approval requests, which are identified in FIG. 2 as 6, 2, and 0, respectively. This may be advantageous because it may allow a realtor to quickly gauge the status of multiple transactions or potential transactions with a cursory look and assess where their attention may be needed.

The status panel 310 may comprise various information relating to clients, including the clients name, co-client, realtor name, loan pre approval status, offer status, actions, and last time updated. Furthermore, the entries in the status panel 315 may comprise hyperlinks that when accessed may allow the realtor to quickly gain more in depth information on matters that require the realtor's attention. In one embodiment, the realtor may request a pre-approval for a loan by using the status panel 310. This may constitute an improvement in the state of the art because it allows realtors to more quickly monitor the status of various potential transactions and apply their attention as needed, sometimes as simply as clicking once to move the transaction along.

The client button 320 may allow the realtor to create a new entry within the status panel for new purchasers.

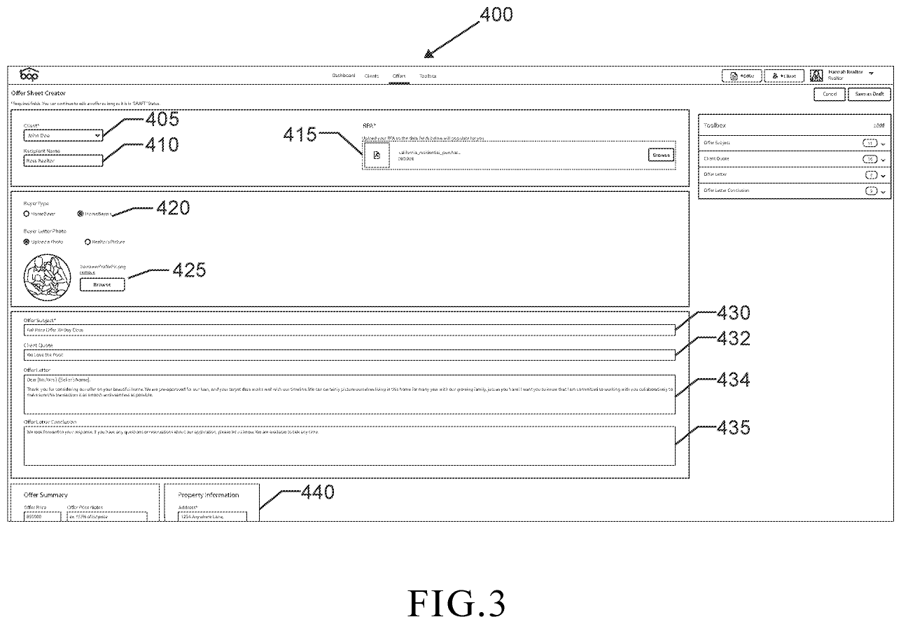

The offer button 315 may allow the realtor to create a new offer by completing the screen as shown in FIG. 3.

FIG. 3 is one embodiment of an offer page of a real estate offer generation program. As shown in FIG. 3, the offer page 400 may comprise a client selector 405, a recipient selector 410, a document upload button 415, a buyer type selector 420, a cover letter photo selector 425, an offer subject 430, a client quote 432, an offer letter 434, an offer letter conclusion 435, and purchase detail fields 440. In one embodiment, the offer page may be accessed when the realtor selects the offer button 315 of FIG. 2. In one embodiment, the offer page may be accessed and used primarily by a realtor.

The client selector 405, may allow the realtor to select a purchaser for the offer being generated. In one embodiment, selecting the purchaser may allow the real estate offer generation program to automatically retrieve information and documents relevant to the specific purchaser based on profile previously created and populated.

The recipient selector 410, may allow the realtor to select the individual or entity to whom the offer being generated will be sent.

The document upload button 415, may allow the realtor to select or upload a residential purchase agreement, which may comprise information that may be extracted and used to create additional entries within the offer page 400 to be filled in or completed by the realtor.

The buyer type selector 420, may allow the realtor to select what type entity the purchaser is, which may include an individual, multiple individuals, or legal entities. The cover letter photo selector 425, may allow the realtor to select a photo, preferably representative of the purchaser, to be included in the offer being generated.

The offer subject 430, may allow the realtor to include a subject line in the offer to be generated. The client quote 432, may allow the realtor to include a quote from the purchaser, preferably a quote related to the real estate to be purchased. The offer letter 434, may allow the realtor to include a brief letter in the offer being generated. The offer letter conclusion 435, may allow the realtor to include a brief conclusion statement to the offer letter in the offer being generated.

The purchase detail fields 440 may allow the realtor to include various details necessary for including the specific figures in the offer to be generated. In one embodiment, the purchase detail fields 440 may be determined based on the residential purchase agreement uploaded via the document upload button 415.

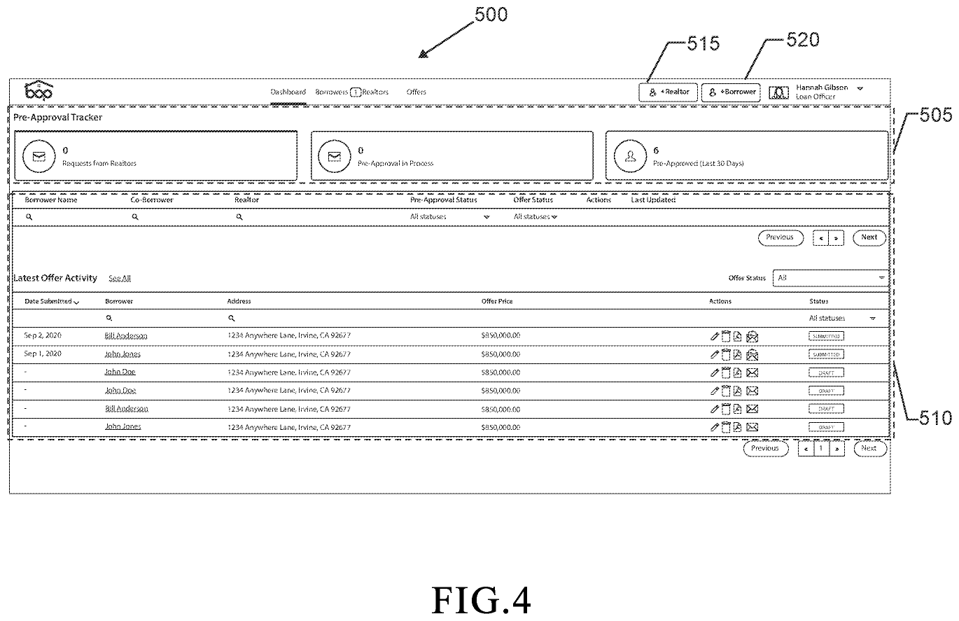

FIG. 4 is one embodiment of a loan electronic dashboard of a real estate offer generation program. As shown in FIG. 4, the real estate offer generation program may include a loan electronic dashboard 500 available to a loan officer, so that the loan officer may manage and organize various clients and monitor progress with respect to preparing loan pre-approval and financial documents, including automatic notification to a realtor regarding status of the same. In one embodiment, the loan electronic dashboard 500 may be accessed and used primarily by a loan officer.

The loan electronic dashboard 500 may comprise an overview panel 505, a status panel 510, a realtor button 515, and a borrower button 520. The overview panel 505 may provide access to commonly used screens, and include a number that indicates a summary of pending information. For example, the overview panel 505 may show the number of requests from realtors, pre-approvals in progress, and pre-approvals, which are identified in FIG. 4 as 0, 0, and 6, respectively. This may be advantageous because it may allow a loan officer to quickly gauge the status of multiple transactions or potential transactions with a cursory look and assess where their attention may be needed.

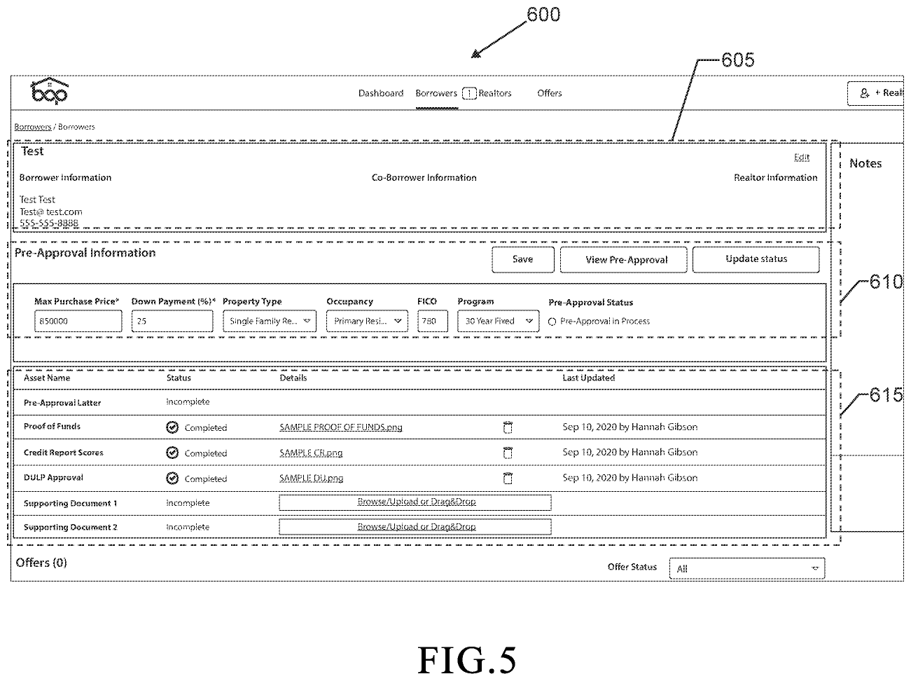

The status panel 510 may comprise various information relating to pre-approval loan projects, including the borrower's name, co-borrower, realtor name, loan pre approval status, offer status, actions, and last time updated. Furthermore, the entries in the status panel 510 may comprise hyperlinks that when accessed may allow the loan officer to quickly gain more in depth information on matters that require the loan officer's attention. In one embodiment, the loan officer may receive a request to prepare a pre-approval for a loan from a realtor as described in FIG. 2, and receive this request within the status panel 510. This constitutes an improvement in the state of the art because it allows loan officers to more quickly receive and monitor the status of various potential transactions and apply their attention as needed. For example, the loan officer may click on a borrower's name, which may be a hyperlink, to go to a loan pre-approval page for that borrower, as shown in FIG. 5.

The realtor button 515 may allow the loan officer to create a new relationships and connections with realtors that utilize the real estate offer generation program.

The borrower button 520 may allow the loan officer to create a entry in the status panel 510. In a preferred embodiment, additional entries in the status panel 510 may be created when a realtor requests a pre-approval as described hereinabove. When the realtor requests a pre-approval, the information prepared by the realtor may be automatically transferred to the loan officer through the status panel 510.

FIG. 5 is one embodiment of a loan pre-approval page of a real estate offer generation program. As shown in FIG. 5, the loan pre-approval page 600 may comprise an information panel 605, a pre-approval information summary 610, and a documents panel 615.

The information panel 605 may comprise information pertaining to the borrower, co-borrower, and realtor related to a particular project.

The pre-approval information summary 610 may allow financial information about the specific loan being requested to be entered by the loan officer or imported directly from information inputed by the realtor. Some of the financial information may include a maximum purchase price, down payment percentage, property type, occupancy, credit score, and type of loan.

The documents panel 615 may allow the loan officer to upload financial documents that may be required to obtain pre-approval. In a preferred embodiment, these uploaded financial documents may be accessible through the real estate offer generation program as accessed by the realtor, such that the financial documents may be automatically included in a purchase offer generated by the realtor, or for any other purpose advantageous or the realtor.

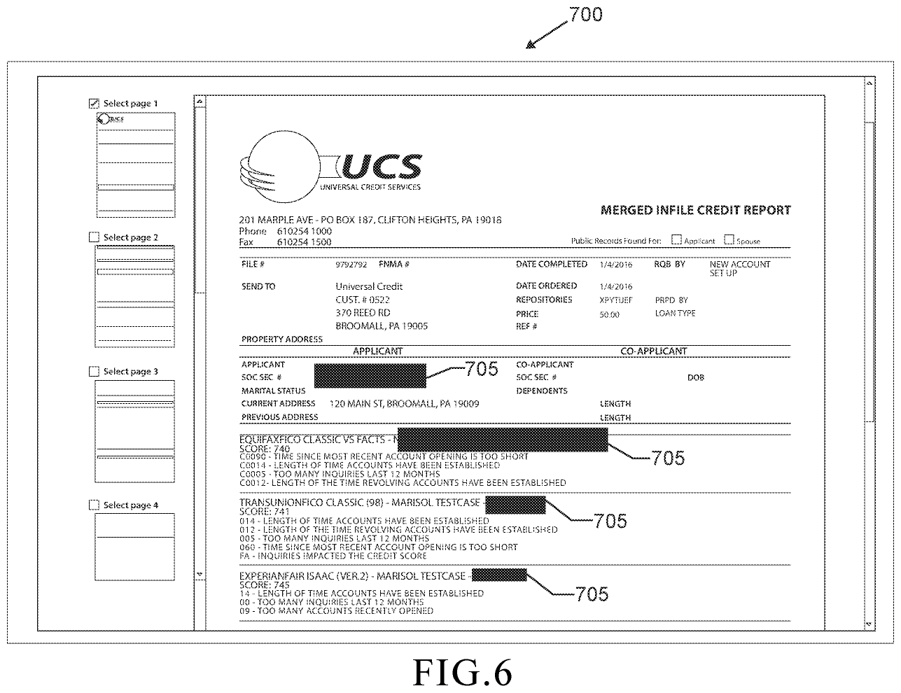

FIG. 6 is a screenshot of one embodiment of a financial document accessed by a real estate offer generation program. As shown in FIG. 6, a financial document 700 uploaded to the real estate offer generation program, as described in FIG. 5, may be modified by a loan officer after the financial document is uploaded to the real estate offer generation program. In one embodiment, the financial document may have one or more portions redacted 705 by causing portions of the financial document to no longer be readable by a subsequent viewer. In some embodiments, when an offer package is generated from financial documents, the offer package may include or reflect the modified versions of the financial documents, rather than the original version of the financial document.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the figures may be performed by processing logic that comprises hardware (e.g. circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

While the present disclosure has been described in terms of particular variations and illustrative figures, those of ordinary skill in the art will recognize that the disclosure is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for generating real estate offers comprising the steps:
providing a real estate transaction application to a realtor and loan officer to be installed on their respective computers;
creating a request for a loan pre-approval document on said real estate transaction application by said realtor;
transmitting, by said real estate transaction application, said request for a loan pre-approval document to said loan officer;
collecting, by said loan officer, one or more financial documents for preparing said loan pre-approval document;
generating, by said loan officer, said loan pre-approval document, wherein said loan pre-approval document is stored on said real estate transaction application;
sending, by said real estate transaction application, to said realtor, an electronic notification that said loan pre-approval document has been prepared by said loan officer;
selecting, by said realtor, a residential purchase agreement document;
extracting data, by said real estate transaction application, from said residential purchase agreement document and said loan pre-approval document; and
generating an offer package by said real estate transaction application.

2. The method for generating real estate offers of claim 1, further comprising the step:
exporting said offer package by said real estate transaction application to a readable format.

3. The method for generating real estate offers of claim 2, further comprising the step:
transmitting, by said real estate transaction application, said offer package in said readable format to a seller agent.

4. The method for generating real estate offers of claim 1, wherein said one or more financial documents are uploaded to said real estate transaction application.

5. The method for generating real estate offers of claim 4, wherein said one or more financial documents are modified by said loan officer on said real estate transaction application by redacting information.

6. The method for generating real estate offers of claim 1, wherein said offer package comprises said loan pre-approval document, said financial documents, an offer letter, and an offer summary.

7. The method for generating real estate offers of claim 6, wherein said offer summary comprises an offer price, an estimated time to close escrow, a lender, a down payment, a financing amount, and an offer deadline.

8. The method for generating real estate offers of claim 1, wherein said financial documents comprise proof of income documents, proof of funds documents, and credit score documents.

9. A method for generating real estate offers comprising the steps:
providing a real estate transaction platform to a first person and second person via the internet to be accessed on their respective networked computers;
building, on said real estate transaction platform, a purchaser profile by said first person, wherein said purchaser profile comprises information regarding a home purchaser;
creating a request for a loan pre-approval document on said real estate transaction platform by said first person;
transmitting, by said real estate transaction platform, said request for a loan pre-approval document to said second person;
collecting, by said second person, one or more financial documents for preparing said loan pre-approval document;
generating, by said second person, said loan pre-approval document, wherein said loan pre-approval document is stored on said real estate transaction platform;
sending, by said real estate transaction platform, to said first person, an electronic notification that said loan pre-approval document has been prepared by said second person;
selecting, by said first person, a residential purchase agreement document;
extracting data, by said real estate transaction platform, from said residential purchase agreement document and said loan pre-approval document; and
generating an offer package by said real estate transaction platform.

10. The method for generating real estate offers of claim 9, further comprising the step:
exporting said offer package by said real estate transaction platform to a readable format.

11. The method for generating real estate offers of claim 10, further comprising the step:
transmitting, by said real estate transaction platform, said offer package in said readable format to a seller agent.

12. The method for generating real estate offers of claim 9, wherein said one or more financial documents are uploaded to said real estate transaction platform.

13. The method for generating real estate offers of claim 12, wherein said offer package comprises said loan pre-approval document, said financial documents, an offer letter, and an offer summary.

14. The method for generating real estate offers of claim 13, wherein said offer summary comprises an offer price, an estimated time to close escrow, a lender, a down payment, a financing amount, and an offer deadline.

15. The method for generating real estate offers of claim 14, wherein said financial documents comprise proof of income documents, proof of funds documents, and credit score documents.

16. The method for generating real estate offers of claim 9, wherein said real estate transaction platform converts said loan pre-approval document and financial documents into a single format.

17. The method for generating real estate offers of claim 16, wherein said real estate transaction platform combines said loan pre-approval document and said financial documents into a single reference document.

18. The method for generating real estate offers of claim 9, wherein said one or more financial documents are modified by said loan officer on said real estate transaction application by redacting information.
